(19) United States
(12) Patent Application Publication
(10) Pub. No.: US 2016/0051999 A1
(43) Pub. Date: Feb. 25, 2016

(54) INDUSTRIAL MISTING FAN WITH MOBILITY CONTROL AND METHOD FOR CONTROLLING AN INDUSTRIAL MISTING FAN

(71) Applicant: C.W. Machine Worx, Ltd., Carroll, OH (US)

(72) Inventors: Patrick Duhaime, Lancaster, OH (US); Hugh Gordon, Lancaster, OH (US); Eric Thornton, Lancaster, OH (US)

(73) Assignee: C.W. Machine Worx, Ltd., Carroll, OH (US)

(21) Appl. No.: 14/466,503

(22) Filed: Aug. 22, 2014

(51) Int. Cl. B05B 7/00

(52) U.S. Cl. CPC B05B 7/0093; B05B 7/0075

(57) ABSTRACT

An industrial misting fan with mobility control and a method of controlling an industrial misting fan comprise a blower unit comprising an air conduit, a plurality of spray nozzles positioned to supply a spray of liquid to the air conduit, and a fan positioned to supply a stream of air through the air conduit, a liquid conduit adapted to supply a pressurized sprayable liquid to the plurality of spray nozzles, a base comprising a propulsion unit that propels the industrial misting fan from a first geographic location to a second geographic location, a power unit comprising a power source that supplies power to at least one of the blower unit and the base, and an industrial misting fan controller configured to receive input of data and produce output of at least one command signal for operating the industrial misting fan.

### TECHNICAL FIELD FOR THE INVENTION

The present invention relates to industrial misting fans and, in particular, industrial misting fan units with mobility control and methods for controlling the mobility of industrial misting fans.

### BACKGROUND OF THE INVENTION

Municipal solid waste landfill operators must cover all disposed waste at the end of each day to control odors, vectors, fires, litter, and scavenging. Federal regulations require landfill operators to use a minimum of six inches of earthen materials as daily cover. Using soil as daily cover requires either excavating material from a borrow area at the landfill site or importing material from off-site. Cover consisting of six inches of soil suffers from major drawbacks such as its waste of valuable airspace, the costs of excavating, loading, and hauling on-site soil, the cost of procuring off-site soil, and impedance of the movement of landfill gas and leachate.

Coal is the fossil fuel most challenging in terms of providing clean energy. Aside from the large volume of gaseous emissions, the remainder of coal waste takes the form of coal combustion residuals, or coal ash, which may contain a variety of toxic metals such as arsenic, cadmium, chromium, mercury, lead, and radium. The United States produces roughly 130 million tons of coal ash each year, a majority of it typically being left in lined or unlined holding ponds or landfills in perpetuity.

The coal ash may not simply remain in the storage ponds or landfills. Coal ash stored in ponds may break out of its holding area, as happened in 2008 at the TVA Kingston Fossil Plant in Kingston, Tenn. That breach sent 1.1 billion gallons of coal ash slurry spewing over 300 acres of nearby land and into the Emory River and Clinch River. Even when a catastrophic breach does not occur, more often than not, toxic material from coal ash ponds slowly leaches out into neighboring streams and lakes. Additionally, coal ash from landfills can be lofted into the air and carried miles downwind, covering homes, cars, and playgrounds with a coating of the toxic materials.

Industrial misting fans, such as those detailed in U.S. Pat. No. 8,657,941, U.S. Provisional Patent Application No. 61/720,864, U.S. Provisional Patent Application No. 61/895,142, and U.S. patent application Ser. No. 14/043,903 (hereby incorporated herein by reference), may be temporarily fixed at a location for conducting an operation relating to application of alternative daily cover, leachate evaporation, or atmospheric control. However, in order to efficiently distribute a liquid supply of such materials as water, leachate, or a mixture that includes either, there exists a need to relocate an industrial misting fan in accordance with the ongoing operation of the worksite.

Remotely controlled or autonomous worksite vehicles, including those that utilize avoidance systems, have been contemplated by U.S. Pat. No. 8,527,155 to Gudat, which is incorporated herein by reference. Additionally, stereo imaging systems mounted on an industrial vehicle have been contemplated by such inventions as U.S. Pat. No. 7,865,285 to Price, et al., which is also incorporated herein by reference. A navigation and control system with proximity detection by utilizing markers to guide an autonomous vehicle is disclosed U.S. Pat. No. 8,232,888 to Frederick, et al., which is also incorporated herein by reference.

However, unlike a typical worksite industrial vehicle, such as a dump truck or excavator, an industrial misting fan operates using a very high volumetric flow rate of liquid supply. Merely relocating the industrial misting fan at various times presents control and logistical issues due to the need to relocate the large volume of liquid supply. Moreover, the sporadic relocation and fixing of an industrial misting fan without mobility control upsets worksite operation and burdens the availability of manpower. In order to comply with environmental regulations, there is a need to monitor atmospheric conditions regularly and provide on-demand control of the environmental, atmospheric, or site conditions.

Accordingly, there remains a need for industrial misting fan units adapted to dispense alternative daily cover materials to random sites within a constantly changing topographical environment of a landfill.

### SUMMARY OF THE INVENTION

In accordance with one aspect of the present invention, an industrial misting fan unit is provided comprising a blower unit comprising an air conduit, a plurality of spray nozzles positioned to supply a spray of liquid to the air conduit, and a fan positioned to supply a stream of air through the air conduit, a liquid conduit adapted to supply a pressurized sprayable liquid to the plurality of spray nozzles, a base comprising a propulsion unit that propels the industrial misting fan from a first geographic location to a second geographic location, at least one power unit comprising one or more power source(s) that supplies power to the blower unit and/or the base, and an industrial misting fan controller configured to receive input of data and produce output of at least one command signal for operating the industrial misting fan.

The present invention may be considered an improvement over the industrial sprayer described in U.S. Pat. No. 8,657,941, which is hereby incorporated herein by reference.

The power source may comprise an internal combustion engine. The internal combustion engine may be a diesel engine. The blower unit may further comprise an electric motor. The power source may comprise at least one battery to supply power to the electric motor. The industrial misting fan unit may further comprise at least one photovoltaic cell panel configured to assist recharging of the at least one battery. The industrial misting fan controller may comprise a receiver configured to receive one or more signal(s) for production of at least one command signal for operation of the industrial misting fan unit. The signal(s) may comprise a wireless signal transmitted to the receiver from an operator at a remote location. The industrial misting fan unit may further comprise a camera module and transmitter configured to transmit visual images captured by the camera module to a remote location, and to which an operator may react to guide the unit. The industrial misting fan unit may further comprise at least one external sensor configured to sense one or more conditions, wherein the industrial misting fan controller receives input of data from the external sensor. The external sensor may comprise one or more global positioning system sensor(s), infrared sensor(s), laser sensor(s), radar sensor(s), sonar sensor(s), magnetometer(s), and/or inertial measurement unit(s) to gather and send data to the industrial misting fan controller. The industrial misting fan controller may be configured to produce command signals for operating the industrial misting fan based on location, movement, or environment data input received by the industrial misting fan controller from the external sensor(s). The command signals may be directed to initiating translocation of the industrial misting fan unit from a first geographic location toward a second geographic location and/or to control the direction and/or altitude and/or attitude of the industrial misting fan unit. The external sensor may comprise an atmospheric sensor that supplies data to the industrial misting fan controller relating to atmospheric conditions. The propulsion unit may comprise a continuous track and/or wheels to guide and/or propel the industrial misting fan from a first geographic location to a second geographic location. The industrial misting fan unit may further comprise a liquid source connected to the liquid conduit. The liquid source may comprise a stationary liquid storage site, or a mobile liquid storage container, the mobile liquid storage container coupled to the base for common movement of the mobile liquid storage container and the base. The power source may comprise an internal combustion engine, an electric motor, and one or more batteries to power the electric motor(s).

In accordance with another aspect of the present invention, a method of controlling such industrial misting fan unit is provided comprising (a) providing a blower unit comprising an air conduit, a fan supplying a stream of air through the air conduit, a plurality of spray nozzles, and supplying a pressurized spray of liquid to the air conduit, and a power unit supplying power to at least one of the blower unit and the base via a power source, (b) propelling the industrial misting fan unit from a first geographic location to a second geographic location via a propulsion unit of a base of the industrial misting fan unit, (c) receiving data input with regard to an operational status of the industrial misting fan unit, and (d) producing an output of one or more command signal(s) based on data input received for operating the industrial misting fan unit.

The power source may comprise an internal combustion engine, such as a diesel engine. The blower unit may further comprise an electric motor. The power source may comprise at least one battery to supply power to the electric motor. The method of controlling an industrial misting fan unit may further comprise assisting recharging of the batter(ies) with at least one photovoltaic cell panel. The method of controlling an industrial misting fan unit may further comprise receiving at a receiver one or more transmitted signal(s) for production of one or more command signal(s) for operation of the industrial misting fan unit. The one or more transmitted signal(s) may comprise wireless signal(s) transmitted to the receiver from an operator at a remote location. The method of controlling an industrial misting fan unit may further comprise transmitting via a transmitter one or more image(s) captured by a camera module to a remote location. The method of controlling an industrial misting fan unit may further comprise sensing one or more conditions with one or more external sensor(s) and receiving input of data from the external sensor(s) to affect the at least one command signal(s). The method of controlling an industrial misting fan unit may further comprise sensing one or more condition(s), such as sensing with one or more of a global positioning system sensor(s), infrared sensor(s), laser sensor(s), radar sensor(s), sonar sensor(s), magnetometer(s), and inertial measurement unit(s) to affect one or more command signal(s). The industrial misting fan controller may be configured to produce command signal(s) for operating the industrial misting fan based on location, movement, and/or environment data input received by the industrial misting fan controller from the external sensor(s). The method may further comprise propelling the industrial misting fan unit from a first geographic location toward a second geographic location and/or altering the direction, altitude and/or attitude of the misting fan, based on the command signal(s). The method of controlling an industrial misting fan unit may further comprise receiving data from an atmospheric sensor relating to atmospheric conditions to affect the command signal(s). The method may further comprise directing and propelling the industrial misting fan unit from a first geographic location to a second geographic location with a continuous track and/or wheels of the propulsion unit. The industrial misting fan unit may further comprise a liquid source connected to the liquid conduit, the liquid source optionally comprising a stationary liquid storage site. The method may further comprise towing the liquid source as a mobile liquid storage container for common movement of the mobile liquid storage container and the base.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is an elevation view of an industrial misting fan unit in accordance with aspects of the present invention;

FIG. 2 is an elevation view of an industrial misting fan unit in accordance with further aspects of the present invention;

FIG. 3 is an elevation view of an industrial misting fan unit in accordance with further aspects of the present invention;

FIG. 4 is an elevation view of an industrial misting fan unit in accordance with further aspects of the present invention; and

FIG. 5 is a schematic representation of a worksite including an industrial misting fan with mobility control in accordance with further aspects of the present invention.

### DETAILED DESCRIPTION

In the following detailed description of the preferred embodiment, reference is made to the accompanying drawings that form a part hereof, and in which is shown by way of illustration, and not by way of limitation, specific preferred embodiment(s) through which the invention may be practiced. It is to be understood that other embodiments may be utilized and that changes may be made without departing from the spirit and scope of the present invention.

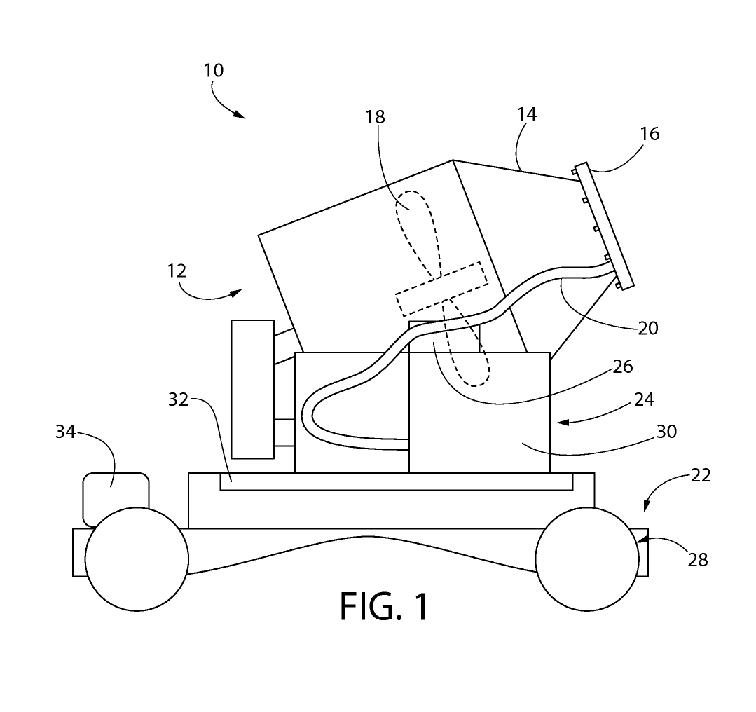

Reference is now made to FIG. 1, which shows an industrial misting fan unit 10 according to a preferred embodiment of the present invention. The industrial misting fan unit 10 of the preferred embodiment includes a blower unit 12 mounted atop the industrial misting fan unit 10. The blower unit 12 of the preferred embodiment is capable of rotation about 360 degrees and includes an air conduit 14, a plurality of spray nozzles 16 in the form of a circular array positioned to supply a spray of liquid to the air conduit 14, and a fan 18 configured and positioned to propel a supply of air axially through the air conduit 14, as shown in FIG. 1. The industrial misting fan unit 10 of the preferred embodiment further includes a liquid conduit 20 that is adapted to supply a pressurized sprayable liquid to the plurality of spray nozzles 16. The sprayable liquid of the present invention may include water, leachate, or a sprayable liquid or suspension of any viscosity comprising either water or leachate. If leachate is used as the sprayable liquid, it may be sourced locally from the worksite or from a remote location.

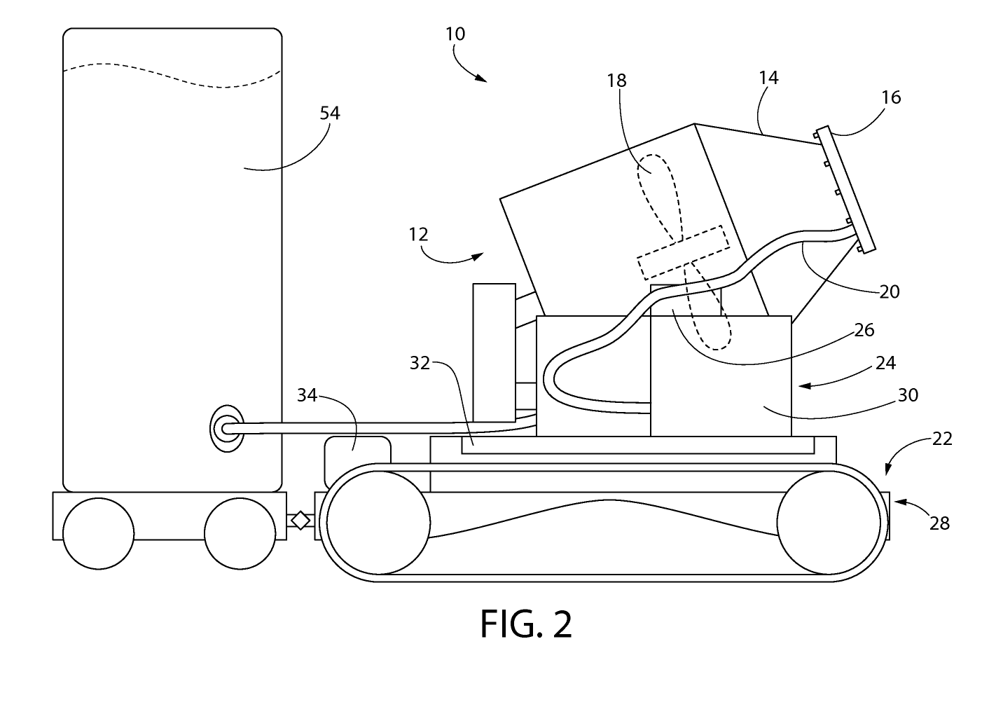

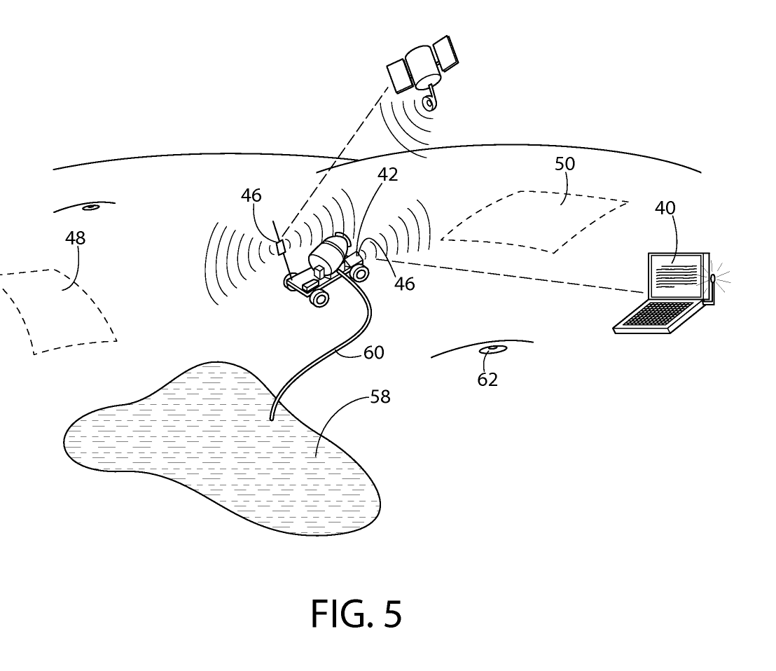

The industrial misting fan unit 10 of the preferred embodiment further includes a base 22, a power unit 24, and an industrial misting fan controller 26. The base 22 of the preferred embodiment includes a propulsion unit 28 that propels the industrial misting fan unit 10 from a first geographic location 48 to a second geographic location 50, as shown in FIG. 5. The propulsion unit 28 of the preferred embodiment shown in FIG. 1 includes wheels that propel the industrial misting fan unit 10 across a worksite path. Alternatively, as shown in FIG. 2, the propulsion unit 28 may include continuous track for added traction during propulsion of the vehicle along a worksite path.

The power unit 24 includes a power source 30 that supplies power to the blower unit 12, the base 22, or both. In the preferred embodiment, the power source 30 is an internal combustion engine and, in particular, a diesel engine. However, any type of internal or external combustion engine may be used as a power source, or the power source 30 may include one or more batteries 32 to supply power to one or more electric motors 34. The industrial misting fan unit 10 of the present invention may comprise a hybrid power source wherein both internal combustion engine(s) and electric battery/motor power are utilized. The blower unit 12 may include an electric motor to power the fan 18, the rotational function of the blower unit 12, a tilting function of the blower unit 12, or a liquid supply pump.

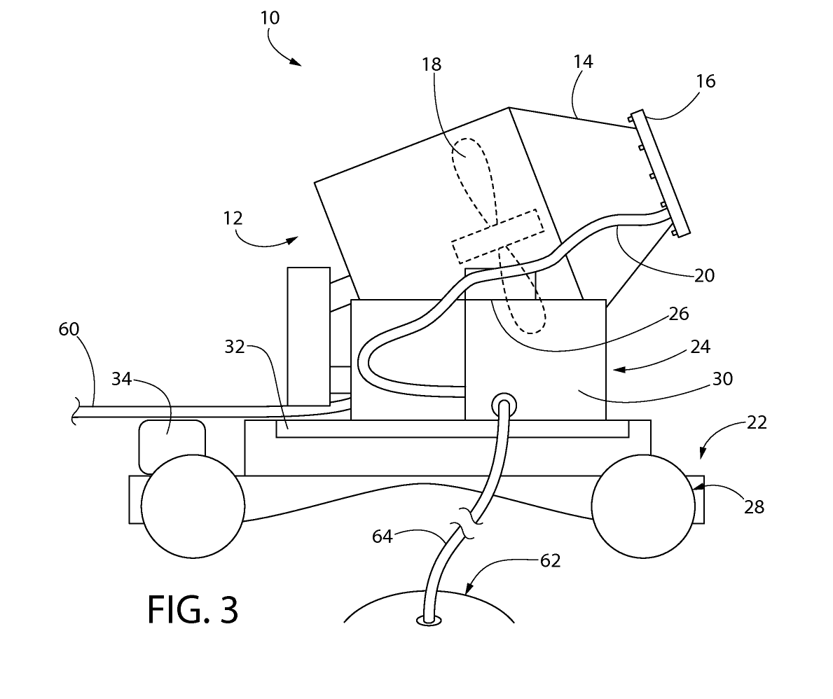

In the case of a worksite being a landfill, combustible gases may be released at multiple locations having an outlet 62 at the top surface of the worksite. As a result, the industrial misting fan unit 10 of the present invention may utilize these combustible gases as fuel for an internal or external combustion engine to power the industrial misting fan unit 10. As shown in FIG. 3, one embodiment of the present invention may include a conduit 64 that is coupled to one or more of the outlets 62. The industrial misting fan unit 10 may travel to multiple locations while remaining connected to an outlet 62, or may reconnect to nearby outlets 62 as the vehicle 10 travels.

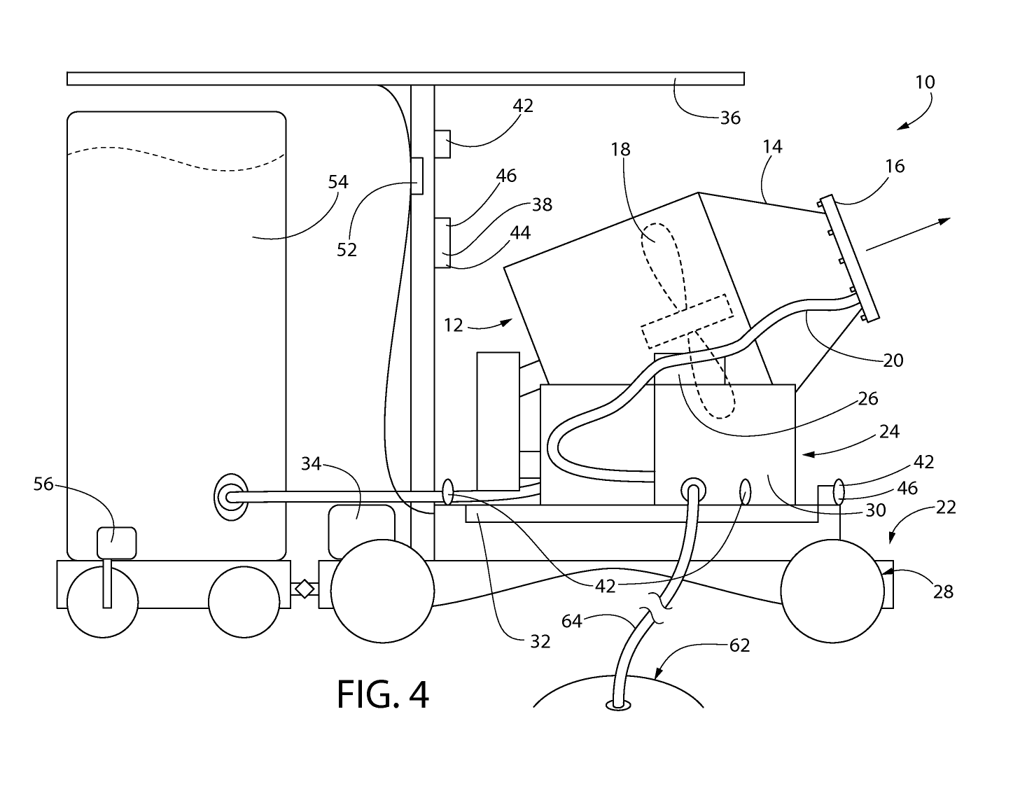

Referring now to FIG. 4, a preferred embodiment of the industrial misting fan unit 10 includes one or more photovoltaic panels 36. The solar panels 36 in the preferred embodiment charge or recharge the one or more batteries 32 housed on board the industrial misting fan unit 10. However, one or more panels 36 may be used to supply power to any other device of the industrial misting fan unit 10.

The industrial misting fan controller 26 is configured to receive data input and produce output of one or more command signals for operating the industrial misting fan unit 10. The data input in the preferred embodiment is in the form of signals sent from one or more sensors relating to location, navigation status, atmospheric condition, operation status, fuel/battery level, or liquid supply level/rate or signals sent from a local or remote location relating to a desired operation. The industrial misting fan controller 26 of the preferred embodiment includes a receiver 38 that is configured to receive one or more desired operation signals. The desired operation signals then directly, or through processing, produce at least one command signal for operation of the industrial misting fan unit 10. The desired operation signals of the preferred embodiment are sent from a hand-held transmitter hard-wired to the controller 26 or wirelessly transmitted from a transmitter such as a transceiver or laptop 40. It is desirable to locate the operator of the industrial misting fan unit 10 remotely off-site in order to prevent interference with ongoing operations, allow multiple industrial misting fan units 10 to be controlled simultaneously by one operator, or prevent injury to the operator due to conditions or ongoing operations.

The industrial misting fan controller 26 of a preferred embodiment shown in FIG. 4 is further configured to receive data input from one or more cameras 42. A camera 42 may be located at a front end of the industrial misting fan 10 in order to provide a frontal view of the path along which the industrial misting fan unit 10 is traveling. Additional cameras 42 may be positioned at the sides, rear, top, or bottom of the vehicle in order to provide the operator with unlimited viewing of the worksite. Also, any of the cameras 42 may include a pan and tilt function such that each may move in a given direction according to a desired operation signal received at the controller 26 from the operator or a control signal automatically sent to the camera 42 based on a program algorithm.

In the preferred embodiments shown in FIGS. 4 and 5, the image data captured by the cameras 42 are sent to a transmitter 44 that transmits the image signal to a receiving location 40 having a receiver, transceiver, laptop, or other signal receiving device where the operator is capable of receiving and viewing the image or images captured by the cameras 42.

In the case of autonomous or semi-autonomous operation and/or navigation, as shown in FIGS. 4 and 5, the cameras 42 may be replaced or supplemented by one or more autonomous vehicle navigation sensors 46 such as global positioning system sensors, laser sensors, radar sensors, laser range finder devices, infrared sensors, sonar sensors, lidar systems, magnetometers, inertial measurement devices, or other navigation sensors known in the art of autonomous vehicles. The information received by such cameras 42 and/or external sensors 46 may be sent to the controller 26 to produce output of one or more command signals based on location, movement, or environment data input received by the industrial misting fan controller 26 from the cameras 42 and/or external sensors 46.

Referring now to FIG. 5, in a preferred embodiment of the present invention, a command signal resulting from information received from cameras 42 or sensors 46 is directed to propelling the industrial misting fan unit 10 from a first geographic location 48 toward a second geographic location 50. The external sensors 46 of the preferred embodiment also include one or more atmospheric sensors 52, such as atmospheric particulate or dust monitoring devices, that supplies data to the controller 26 relating to atmospheric conditions, such as an airborne dust or debris concentration.

Dust and particular monitoring equipment and/or sensors may be mounted on the industrial misting fan unit 10 to activate the industrial misting fan unit or to control the direction, location, or duration of the operation of the industrial misting fan unit 10. For example, when the particulate content exceeds a predetermined threshold in a particular location, the industrial misting fan controller may begin operation to suppress the amount of particulate in the atmosphere in a given direction or location. Additionally, such equipment, sensors, or data received from such equipment or sensors may be used to document compliance with environmental regulations. Such information may be stored locally in a memory device onboard the industrial misting fan unit 10, or may be transmitted remotely to a remote memory or data storage location.

Referring again to FIGS. 2 and 3, the industrial misting fan unit 10 of the present invention requires a relatively large supply of liquid to operate. The liquid may be water, leachate from a landfill, or a mixture, suspension, or slurry that includes either water or leachate. In one embodiment shown in FIG. 2, the industrial misting fan unit 10 includes a liquid source 54 in the form of a tank or container being towed behind powered portion of the industrial misting fan unit 10. However, a separate vehicle housing or carrying the liquid source 54 may be powered separately through an electric motor or internal combustion engine 56 and either towed or controlled to travel along or behind the industrial misting fan unit 10. The liquid source 54 in the embodiment of FIG. 2 is connected to the liquid conduit 20 such that liquid is supplied to the liquid conduit 20. The mobile liquid storage container 54 may be coupled to the base 22 for common movement of the mobile liquid storage container 54 and the base 22.

Referring again to FIGS. 3 and 5, one embodiment of the present invention includes a liquid source 58 being a stationary liquid storage site, such as a pond filled at least partially with leachate or water. The liquid conduit 20 of the industrial misting fan unit 10 is connected to the stationary liquid source 58 through a flexible conduit 60 such as a long hose. In order to apply positive pressure to supply liquid from the stationary liquid source 58, a pump may be located at the stationary liquid source 58 or a pump may be located at the liquid conduit 20 if the pump is adequately primed.

The present invention includes a method of controlling an industrial misting fan unit 10. In accordance with one or more embodiments of the present invention, the method of controlling the industrial misting fan unit 10 includes providing a blower unit comprising an air conduit, a plurality of spray nozzles, and a fan, supplying a stream of air through the air conduit, supplying a pressurized spray of liquid to the air conduit via the plurality of spray nozzles, supplying power to at least one of the blower unit and the base via a power source, propelling the industrial misting fan unit from a first geographic location to a second geographic location via a propulsion unit of a base of the industrial misting fan unit, receiving data input with regard to an operational status of the industrial misting fan unit, and producing an output of at least one command signal based on the receiving data input for operating the industrial misting fan unit.

The method of controlling the industrial misting fan unit 10 may further include any of the following steps of: assisting recharging of at least one battery 32 with at least one photovoltaic cell panel 36, receiving at a receiver 38 at least one transmitted signal for production of at least one command signal for operation of the industrial misting fan unit 10, transmitting via a transmitter 44 one or more images captured by a camera module 42 to a remote location, sensing one or more conditions with at least one external sensor 46 and receiving input of data from the external sensor 46 to affect a command signal, sensing with one or more global positioning system sensors, infrared sensors, laser sensors, radar sensors, sonar sensors, magnetometers, or inertial measurement units to affect a command signal, at least partially propelling the industrial misting fan unit 10 from the first geographic location 48 toward the second geographic location 50 based, at least in part, on the command signal, receiving data from an atmospheric sensor relating to atmospheric conditions to affect a command signal, propelling the industrial misting fan unit 10 from the first geographic location 48 to the second geographic location 50 with continuous track of the propulsion unit, propelling the industrial misting fan unit 10 from the first geographic location 48 to the second geographic location 50 with wheels of the propulsion unit 28, or towing the liquid source 54 as a mobile liquid storage container for common movement of the mobile liquid storage container and the base.

While the invention may be rendered in embodiments in many different forms, there have been shown in the drawings and described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

What is claimed is:

1. An industrial misting fan unit, comprising:
a blower unit comprising an air conduit, a plurality of spray nozzles positioned to supply a spray of liquid to said air conduit, and a fan positioned to supply a stream of air through said air conduit;
a liquid conduit adapted to supply a pressurized sprayable liquid to said plurality of spray nozzles;
a base comprising a propulsion unit that propels said industrial misting fan unit from a first geographic location to a second geographic location;
a power unit comprising a power source that supplies power to at least one of said blower unit and said base; and
an industrial misting fan controller configured to receive data input and produce output of at least one command signal for operating said industrial misting fan unit.

2. The industrial misting fan unit of claim 1, wherein said power source comprises an internal combustion engine.

3. The industrial misting fan unit of claim 2, wherein said internal combustion engine is a diesel engine.

4. The industrial misting fan unit of claim 1, wherein said blower unit further comprises an electric motor.

5. The industrial misting fan unit of claim 4, wherein said power source comprises at least one battery to supply power to said electric motor.

6. The industrial misting fan unit of claim 5, further comprising at least one photovoltaic cell panel configured to assist recharging of said at least one battery.

7. The industrial misting fan unit of claim 1, wherein said industrial misting fan controller comprises a receiver configured to receive at least one signal for production of at least one command signal for operation of said industrial misting fan unit.

8. The industrial misting fan unit of claim 7, wherein said at least one signal comprises a wireless signal transmitted to said receiver from an operator at a remote location.

9. The industrial misting fan unit of claim 1, further comprising a camera module and transmitter configured to transmit visual images captured by said camera module to a remote location.

10. The industrial misting fan unit of claim 1, further comprising at least one external sensor configured to sense one or more conditions, wherein said industrial misting fan controller receives input of data from said external sensor.

11. The industrial misting fan unit of claim 10, wherein said external sensor comprises at least one of a global positioning system sensor, an infrared sensor, a laser sensor, a radar sensor, a sonar sensor, a magnetometer, and an inertial measurement unit to send data to said industrial misting fan controller.

12. The industrial misting fan unit of claim 10, wherein said industrial misting fan controller is configured to produce at least one command signal for operating said industrial misting fan based on location, movement, or environment data input received by said industrial misting fan controller from said external sensor.

13. The industrial misting fan unit of claim 12, wherein said at least one command signal is directed to at least partially propelling said industrial misting fan unit from said first geographic location toward said second geographic location.

14. The industrial misting fan unit of claim 10, wherein said external sensor comprises an atmospheric sensor that supplies data to said industrial misting fan controller relating to atmospheric conditions.

15. The industrial misting fan unit of claim 1, wherein said propulsion unit comprises continuous track to propel said industrial misting fan unit from a first geographic location to a second geographic location.

16. The industrial misting fan unit of claim 1, wherein said propulsion unit comprises wheels to propel said industrial misting fan unit from a first geographic location to a second geographic location.

17. The industrial misting fan unit of claim 1, wherein said industrial misting fan unit further comprises a liquid source connected to said liquid conduit.

18. The industrial misting fan unit of claim 17, wherein said liquid source comprises a stationary liquid storage site.

19. The industrial misting fan unit of claim 17, wherein said liquid source comprises a mobile liquid storage container, said mobile liquid storage container coupled to said base for common movement of said mobile liquid storage container and said base.

20. The industrial misting fan unit of claim 1, wherein said power source comprises an internal combustion engine, an electric motor, and at least one battery to power at least said electric motor.

21. A method of controlling an industrial misting fan unit, comprising:
providing a blower unit comprising an air conduit, a plurality of spray nozzles, and a fan;
supplying a stream of air through said air conduit;
supplying a pressurized spray of liquid to said air conduit via said plurality of spray nozzles;
supplying power to at least one of said blower unit and said base via a power source;
propelling said industrial misting fan unit from a first geographic location to a second geographic location via a propulsion unit of a base of said industrial misting fan unit;
receiving data input with regard to an operational status of said industrial misting fan unit; and
producing an output of at least one command signal based on said receiving data input for operating said industrial misting fan unit.

22. The method of controlling an industrial misting fan unit of claim 21, wherein said power source comprises an internal combustion engine.

23. The method of controlling an industrial misting fan unit of claim 22, wherein said internal combustion engine is a diesel engine.

24. The method of controlling an industrial misting fan unit of claim 21, wherein said blower unit further comprises an electric motor.

25. The method of controlling an industrial misting fan unit of claim 24, wherein said power source comprises at least one battery to supply power to said electric motor.

26. The method of controlling an industrial misting fan unit of claim 25, further comprising assisting recharging of said at least one battery with at least one photovoltaic cell panel.

27. The method of controlling an industrial misting fan unit of claim 21, further comprising receiving at a receiver at least one transmitted signal for production of at least one command signal for operation of said industrial misting fan unit.

28. The method of controlling an industrial misting fan unit of claim 27, wherein said at least one transmitted signal comprises a wireless signal transmitted to said receiver from an operator at a remote location.

29. The method of controlling an industrial misting fan unit of claim 21, further comprising transmitting via a transmitter one or more images captured by a camera module to a remote location.

30. The method of controlling an industrial misting fan unit of claim 21, further comprising sensing one or more conditions with at least one external sensor and receiving input of data from said external sensor to affect said at least one command signal.

31. The method of controlling an industrial misting fan unit of claim 30, wherein said sensing one or more conditions comprises sensing with at least one of a global positioning system sensor, an infrared sensor, a laser sensor, a radar sensor, a sonar sensor, a magnetometer, and an inertial measurement unit to affect said at least one command signal.

32. The method of controlling an industrial misting fan unit of claim 30, wherein said industrial misting fan controller is configured to produce at least one command signal for operating said industrial misting fan based on location, movement, or environment data input received by said industrial misting fan controller from said external sensor.

33. The method of controlling an industrial misting fan unit of claim 32, further comprising at least partially propelling said industrial misting fan unit from said first geographic location toward said second geographic location based on said at least one command signal.

34. The method of controlling an industrial misting fan unit of claim 30, further comprising receiving data from an atmospheric sensor relating to atmospheric conditions to affect said at least one command signal.

35. The method of controlling an industrial misting fan unit of claim 21, further comprising propelling said industrial misting fan unit from said first geographic location to said second geographic location with continuous track of said propulsion unit.

36. The method of controlling an industrial misting fan unit of claim 21, further comprising propelling said industrial misting fan unit from said first geographic location to said second geographic location with wheels of said propulsion unit.

37. The method of controlling an industrial misting fan unit of claim 21, wherein said industrial misting fan unit further comprises a liquid source connected to said liquid conduit.

38. The method of controlling an industrial misting fan unit of claim 37, wherein said liquid source comprises a stationary liquid storage site.

39. The method of controlling an industrial misting fan unit of claim 37, further comprising towing said liquid source as a mobile liquid storage container for common movement of said mobile liquid storage container and said base.
